(19) United States
(12) Patent Application Publication
(10) Pub. No.: US 2024/0403212 A1
(43) Pub. Date: Dec. 5, 2024

(54) COMPUTER-READABLE RECORDING MEDIUM STORING DATA PROCESSING PROGRAM, DATA PROCESSING DEVICE, AND DATA PROCESSING SYSTEM

(71) Applicant: Fujitsu Limited, Kawasaki-shi (JP)

(72) Inventor: Kota MIYAKE, Kawasaki (JP)

(73) Assignee: Fujitsu Limited, Kawasaki-shi (JP)

(21) Appl. No.: 18/677,988

(22) Filed: May 30, 2024

(30) Foreign Application Priority Data
Jun. 2, 2023 (JP) 2023-091523

(51) Int. Cl. G06F 12/0802

(52) U.S. Cl. CPC G06F 12/0802

(57) ABSTRACT

A non-transitory computer-readable recording medium storing a data processing program for causing a computer to execute a process, the process includes, obtaining, from a terminal of a viewer of data, the terminal requesting generation of an endorsement graph, a list in which an issuer of endorsement data trusted by the viewer is defined, when the generation of the endorsement graph in which connection of the endorsement data to which authenticity of data over an Internet is endorsed is graphed is requested, and caching at least a part of the endorsement graph determined based on the list.

### CROSS-REFERENCE TO RELATED APPLICATION

This application is based upon and claims the benefit of priority of the prior Japanese Patent Application No. 2023-91523, filed on Jun. 2, 2023, the entire contents of which are incorporated herein by reference.

### FIELD

The embodiments discussed herein are related to a data processing program, a data processing device, and a data processing system.

### BACKGROUND

Among data sent (e.g., posted, etc.) on the Internet, there are data with correct contents and data with incorrect contents, such as what is called misinformation. As a countermeasure against such misinformation, there has been proposed an architecture called a Trustable Internet.

In the Trustable Internet, endorsement data that gives an endorsement to authenticity of data on the Internet is used. The endorsement data includes, for example, information regarding an issuer that has issued the endorsement data. The issuer may be an individual or a public institution, or may be an object (e.g., sensor, etc.). In the Trustable Internet, data on the Internet is associated with the endorsement data so that reliability of contents represented by the data is improved.

Furthermore, in the Trustable Internet, there is provided an endorsement graph that expresses, in a directed graph, what kind of connection the endorsement data associated with data has with the data as a starting point. The endorsement graph is provided to a terminal of a viewer who views the data by a server used in the Trustable Internet. The viewer is enabled to view the connection of the endorsement data by checking the endorsement graph provided from the server with the terminal. Note that various types of data processing systems that use a directed graph have been known.

Japanese Laid-open Patent Publication No. 2009-043258, Japanese National Publication of International Patent Application No. 2023-503016, U.S. Patent Application Publication No. 2015/0149484, and Trusted Internet Architecture Lab (TIAL), “Trustable Internet”, [online], Oct. 13, 2022, [retrieved on Apr. 18, 2023], Internet <URL: https://tial.sfc.keio.ac.jp/blob/Trustable_Internet_Whitepaper_V1.0.pdf> are disclosed as related art.

### SUMMARY

According to an aspect of the embodiments, a non-transitory computer-readable recording medium storing a data processing program for causing a computer to execute a process, the process includes, obtaining, from a terminal of a viewer of data, the terminal requesting generation of an endorsement graph, a list in which an issuer of endorsement data trusted by the viewer is defined, when the generation of the endorsement graph in which connection of the endorsement data to which authenticity of data over an Internet is endorsed is graphed is requested, and caching at least a part of the endorsement graph determined based on the list.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an exemplary data processing system;

FIG. 2 is an exemplary hardware configuration of a data processing server;

FIG. 3 is an exemplary functional configuration of the data processing server;

FIG. 4 is a diagram for explaining exemplary caching of metadata included in endorsement data;

FIG. 5 is an exemplary endorsement graph based on the metadata;

FIG. 6 is a flowchart illustrating exemplary operation of a data processing server according to a first embodiment;

FIG. 7 is a diagram for explaining an exemplary parallel request of the endorsement data using a trust list;

FIG. 8 is a flowchart illustrating another exemplary operation of the data processing server according to the first embodiment;

FIG. 9 is a diagram for explaining an exemplary parallel request of the endorsement data at a time of cache update;

FIG. 10 is a diagram for explaining exemplary parallel collection of the endorsement data at the time of cache update;

FIG. 11 is a flowchart illustrating an exemplary recursive process;

FIG. 12 is a flowchart illustrating exemplary operation of a data processing server according to a second embodiment;

FIG. 13A is exemplary statistical information based on the trust list of a viewer;

FIG. 13B is exemplary statistical information in which fields are limited;

FIG. 14 is a diagram for explaining exemplary caching of a part of the endorsement graph; and

FIG. 15 is a flowchart illustrating another exemplary operation of the data processing server according to the second embodiment.

### DESCRIPTION OF EMBODIMENTS

The endorsement graph is provided to the terminal of the viewer when generation is requested from the terminal of the viewer to the server. For example, when the viewer requests, via the terminal, the server to generate an endorsement graph associated with predetermined data, the server collects the endorsement data associated with the predetermined data, generates an endorsement graph, and provides it to the terminal of the viewer.

However, as described above, the endorsement graph is a directed graph that expresses what kind of connection the endorsement data associated with data has. Thus, when the server collects primary endorsement data directly associated with the data, it then collects secondary endorsement data indirectly associated with the data (e.g., directly associated with the primary endorsement data). In this manner, the server recursively collects the endorsement data. Then, the server finishes collecting the final endorsement data, thereby generating an endorsement graph to provide it to the terminal of the viewer.

As described above, since the server recursively collects the endorsement data and generates the endorsement graph after collecting the final endorsement data, there is a problem that it takes time to generate the endorsement graph. For example, if servers that manage the endorsement data are scattered all over the world, a communication delay of more than one second may occur, which may raise a possibility that the endorsement graph fails to be promptly provided to the viewer.

Hereinafter, an embodiment of techniques to shorten a generation time of an endorsement graph will be described with reference to the drawings.

### First Embodiment

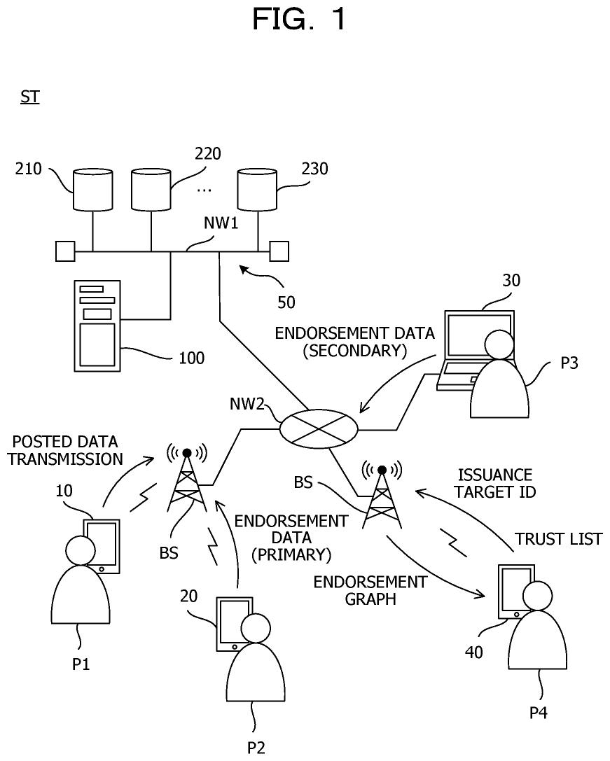

As illustrated in FIG. 1, a data processing system ST includes a plurality of terminal devices 10, 20, 30, and 40, and an endorsement system 50. The endorsement system 50 is a computer system including a data processing server 100 and a plurality of data management servers 210, 220, and 230. The data processing server 100 is an exemplary data processing device. The data processing server 100 and the plurality of data management servers 210, 220, and 230 are coupled via a communication network NW1. The communication network NW1 includes, for example, a local area network (LAN) and a wide area network (WAN). The communication network NW1 may include, for example, the Internet.

Furthermore, the plurality of terminal devices 10, 20, 30, and 40 and the endorsement system 50 are coupled via a communication network NW2 and a portable base station BS. The communication network NW2 includes, for example, the Internet. Note that the terminal devices 10, 20, 30, and 40 include a mobile terminal. The mobile terminal may be a smartphone, a tablet terminal, or a personal computer (PC).

The terminal device 10 is operated by a poster P1 of data. For example, the poster P1 operates the terminal device 10 to send, from the terminal device 10, data related to a political news article or image data including river flooding as posted data. As a result, the posted data reaches the communication network NW2 via the portable base station BS. Although illustration is omitted, a public server that publishes the posted data in the communication network NW2 is coupled to the communication network NW2. Therefore, the posted data is published in the communication network NW2 by the public server. Note that the public server may be implemented by, for example, a server that provides a social networking service (SNS).

The terminal devices 20 and 30 are operated by publishers P2 and P3 of endorsement data that give an endorsement to authenticity of the posted data, respectively. The publishers P2 and P3 are exemplary issuers of the endorsement data. While individuals are illustrated as examples of the publishers P2 and P3 in FIG. 1, they may be corporations (e.g., educational institutions, etc.), public institutions (national governments, local governments, etc.), or persons in charge belonging to those institutions. The issuer of the endorsement data may be a surveillance camera or the like including an image sensor.

For example, the publisher P2 operates the terminal device 20 to send primary endorsement data from the terminal device 20. The primary endorsement data is directly associated with the posted data published in the communication network NW2. The primary endorsement data reaches the communication network NW1 via the portable base station BS and the communication network NW2, and is stored in the data management server 210, for example. As a result, the data management server 210 manages the primary endorsement data.

Meanwhile, the publisher P3 operates the terminal device 30 to send secondary endorsement data from the terminal device 30. The secondary endorsement data is indirectly associated with the posted data. For example, the secondary endorsement data is indirectly associated with the posted data by being directly associated with the primary endorsement data.

The secondary endorsement data reaches the communication network NW1 via the portable base station BS and the communication network NW2, and is stored in the data management server 220, for example. As a result, the data management server 220 manages the secondary endorsement data. In this manner, the primary endorsement data and the secondary endorsement data are decentralized and individually managed in the data management servers 210 and 220. Although illustration is omitted, tertiary to final endorsement data are managed in a similar manner.

The terminal device 40 is operated by a viewer P4 who browses the posted data. In a case of checking the authenticity of the posted data, the viewer P4 operates the terminal device 40 to request the data processing server 100 to generate an endorsement graph. The endorsement graph is a directed graph in which connection of the endorsement data is graphed. Endorsement data corresponds to an edge of the directed graph, and an issuer and an issuance target of the endorsement data correspond to nodes of the directed graph.

When the terminal device 40 is operated by the viewer P4, it transmits a graph generation request of the endorsement graph to the data processing server 100. This graph generation request includes an identifier of the posted data to which the endorsement data is issued as an endorsement data (ED) issuance target identifier (ID) (simply indicated as issuance target ID in FIG. 1). Note that the ID according to the present embodiment includes a decentralized ID (DID).

Although details will be described later, upon reception of the graph generation request, the data processing server 100 obtains a trust list that defines the publishers P2 and P3 of the endorsement data and the like trusted by the viewer P4. In the trust list, the publishers P2 and P3 and the like are defined by the ED issuer ID. Upon acquisition of the trust list, the data processing server 100 collects the endorsement data from at least one of the data management servers 210, 220, or 230 using the trust list and an existing cache status of the endorsement graph managed by the data processing server 100. For example, the data processing server 100 collects the endorsement data not recursively but in parallel.

Upon collection of the endorsement data, the data processing server 100 generates an endorsement graph based on the collected endorsement data, and provides the generated endorsement graph to the terminal device 40 by transmission. As a result, the viewer P4 is enabled to check, via the terminal device 40, the authenticity of the posted data by the endorsement graph. In this manner, the data processing server 100 collects the endorsement data not recursively but in parallel using the existing cache status of the endorsement graph alone or together with the trust list. As a result, it becomes possible to shorten a generation time of the endorsement graph.

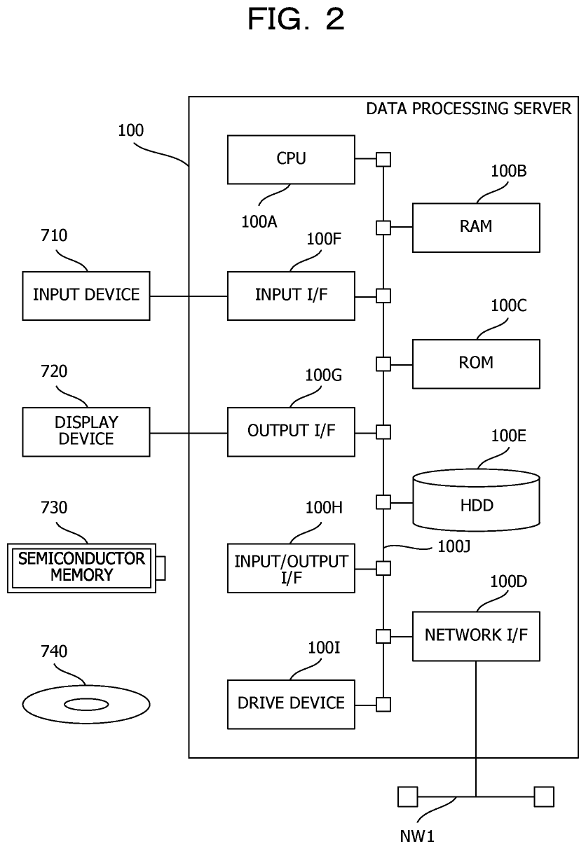

Next, a hardware configuration of the data processing server 100 will be described with reference to FIG. 2. Note that the terminal devices 10, 20, 30, and 40 and the data management servers 210, 220, and 230 described above basically have a hardware configuration similar to that of the data processing server 100, and thus detailed descriptions thereof will be omitted.

The data processing server 100 includes a central processing unit (CPU) 100A as a processor, and a random access memory (RAM) 100B and a read only memory (ROM) 100C as memories. The RAM 100B includes a dynamic RAM (DRAM) and a static RAM (SRAM). The SRAM may be included in the CPU 100A. The data processing server 100 includes a network interface (I/F) 100D and a hard disk drive (HDD) 100E. A solid state drive (SSD) may be adopted instead of the hard disk drive (HDD) 100E.

The data processing server 100 may include, as needed, at least one of an input I/F 100F, an output I/F 100G, an input/output I/F 100H, or a drive device 100I. The CPU 100A to the drive device 100I are coupled to each other by an internal bus 100J. For example, the data processing server 100 may be implemented by a computer.

An input device 710 is coupled to the input I/F 100F. Examples of the input device 710 include a keyboard, a mouse, a touch panel, and the like. A display device 720 is coupled to the output I/F 100G. Examples of the display device 720 include a liquid crystal display and the like. A semiconductor memory 730 is coupled to the input/output I/F 100H. Examples of the semiconductor memory 730 include a universal serial bus (USB) memory, a flash memory, and the like. The input/output I/F 100H reads a data processing program stored in the semiconductor memory 730. The input I/F 100F and the input/output I/F 100H include, for example, USB ports. The output I/F 100G includes, for example, a display port.

A portable recording medium 740 is inserted into the drive device 100I. Examples of the portable recording medium 740 include a removable disk such as a compact disc (CD)-ROM or a digital versatile disc (DVD). The drive device 100I reads a data processing program recorded in the portable recording medium 740. The network I/F 100D includes, for example, a LAN port, a communication circuit, and the like. The communication circuit includes one or both of a wired communication circuit and a wireless communication circuit. The network I/F 100D is coupled to the communication network NW1.

The data processing program stored in at least one of the ROM 100C, the HDD 100E, or the semiconductor memory 730 is temporarily stored in the RAM 100B by the CPU 100A. The data processing program recorded in the portable recording medium 740 is temporarily stored in the RAM 100B by the CPU 100A. With the stored data processing program being executed by the CPU 100A, the CPU 100A implements various functions to be described later, and executes a data processing method including various types of processing to be described later. Note that the data processing program only needs to be in accordance with a flowchart to be described later.

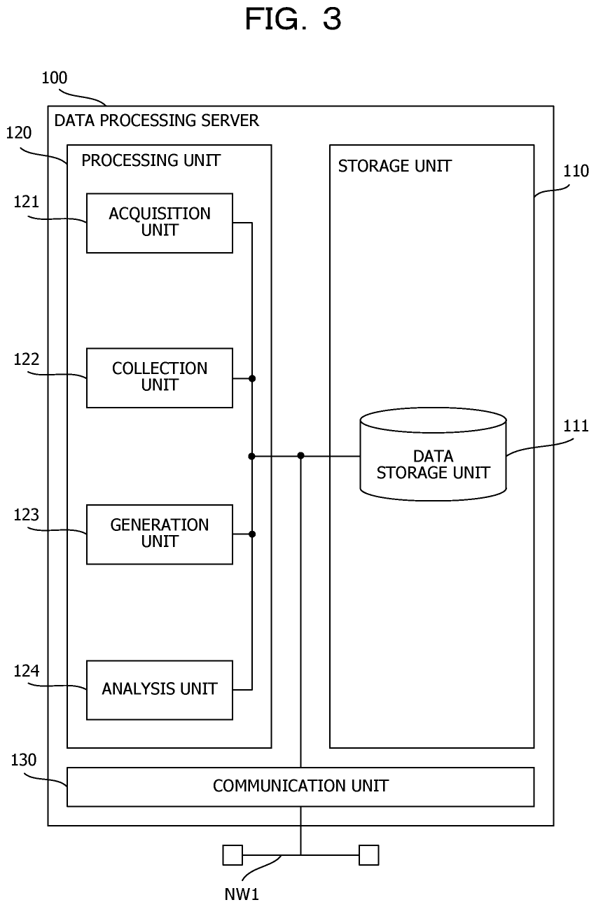

A functional configuration of the data processing server 100 will be described with reference to FIGS. 3 to 5. Note that FIG. 3 illustrates a main part of the functions of the data processing server 100.

As illustrated in FIG. 3, the data processing server 100 includes a storage unit 110, a processing unit 120, and a communication unit 130. The storage unit 110 may be implemented by one or both of the RAM 100B and the HDD 100E described above. The processing unit 120 may be implemented by the CPU 100A described above. The communication unit 130 may be implemented by the network I/F 100D described above. The storage unit 110, the processing unit 120, and the communication unit 130 are coupled to each other. The storage unit 110 includes a data storage unit 111. The processing unit 120 includes an acquisition unit 121, a collection unit 122, a generation unit 123, and an analysis unit 124. The generation unit 123 is an exemplary cache unit.

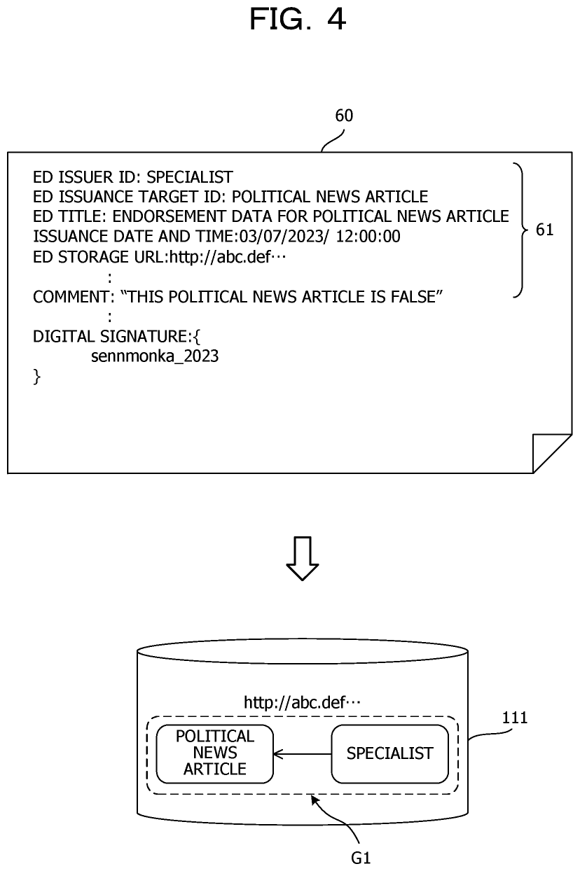

The data storage unit 111 is a cache memory implemented by an SRAM, for example, and stores a part of metadata included in the endorsement data. For example, as illustrated in FIG. 4, when endorsement data 60 is collected, the data storage unit 111 stores a part of metadata 61 included in the endorsement data 60. For example, the data storage unit 111 stores the ED issuer ID “specialist” and the ED issuance target ID “political news article”, which are a part of the metadata 61, in association with each other. Since the endorsement data 60 unidirectionally associates the ED issuer ID “specialist” with the ED issuance target ID “political news article”, the data storage unit 111 is enabled to graphically store the ED issuance target ID “political news article” and the ED issuer ID “specialist”. By graphing the ED issuance target ID “political news article” and the ED issuer ID “specialist”, it becomes possible to achieve a skeletal structure of an endorsement graph G1.

Furthermore, the data storage unit 111 stores an ED storage uniform resource locator (URL) “http://abc.def . . . ”, which is a part of the metadata 61, in association with the skeletal structure of the endorsement graph G1. In this manner, the data storage unit 111 stores three pieces of the metadata 61 of the endorsement data 60, and stores the endorsement graph G1 using two pieces of the metadata 61. Since the ED storage URL is associated with the endorsement graph G1, any one of the data management servers 210, 220, and 230 in which the endorsement data is stored may be uniquely identified by the ED storage URL.

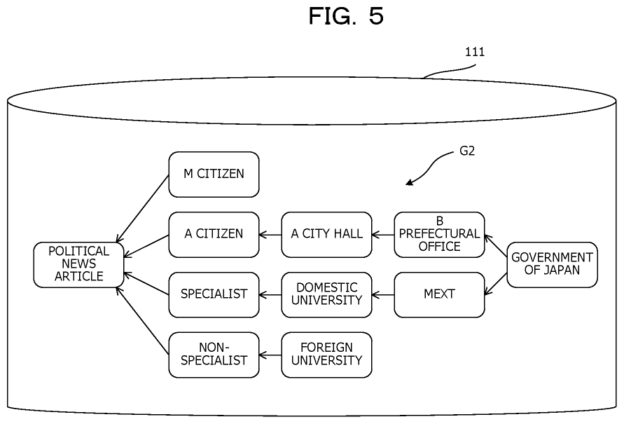

Note that, when various types of endorsement data including the endorsement data 60 are collected, for example, the data storage unit 111 stores an endorsement graph G2 as illustrated in FIG. 5. In FIG. 5, the ED storage URL is omitted. In the endorsement graph G2, the ED issuer ID “specialist” is directly associated with the ED issuance target ID “political news article”. Additionally, an ED issuer ID “domestic university” is directly associated with the ED issuer ID “specialist”. For example, the ED issuer ID “domestic university” is indirectly associated with the ED issuance target ID “political news article” via the ED issuer ID “specialist”. In the relationship between the ED issuer ID “specialist” and the ED issuer ID “domestic university”, the ED issuer ID “specialist” corresponds to the ED issuance target ID, and the ED issuer ID “domestic university” directly corresponds to the ED issuer ID.

In this manner, by using a part of the metadata included in the endorsement data, the primary endorsement data, the secondary endorsement data, and the like are directly or indirectly associated with the posted data. With the primary endorsement data, the secondary endorsement data, and the like being associated with the posted data in a multi-order manner, the endorsement graph G2 is achieved.

Returning to FIG. 3, the acquisition unit 121 receives, from the terminal device 40, the graph generation request of the endorsement graph including the ED issuance target ID. Upon reception of the graph generation request, the acquisition unit 121 requests the terminal device 40 to transmit the trust list, thereby obtaining the trust list. When the acquisition unit 121 obtains the trust list, the collection unit 122 collects the endorsement data. Although details will be described later, when the acquisition unit 121 obtains the trust list, the collection unit 122 first checks the cache status of endorsement graphs stored in the data storage unit 111, and identifies an endorsement graph including the ED issuance target ID included in the graph generation request. Upon identifying the endorsement graph, the collection unit 122 identifies the ED issuer ID with which the ED issuer ID included in the trust list is directly or indirectly associated in one direction. Upon identifying the ED issuer ID, the collection unit 122 collects the endorsement data including the identified ED issuer ID from at least one of the data management servers 210, 220, or 230 in parallel.

The generation unit 123 generates an endorsement graph based on the endorsement data collected by the collection unit 122. Since the endorsement data includes the ED issuance target ID and the ED issuer ID, the generation unit 123 is enabled to generate the endorsement graph by using the relationship between the ED issuance target ID and the ED issuer ID. Upon generation of the endorsement graph, the generation unit 123 caches all or a part of the endorsement graph in the data storage unit 111. As described above, since the collection unit 122 collects the endorsement data based on the trust list, the generation unit 123 is enabled to cache all or a part of the endorsement graph determined based on the trust list. Upon caching the endorsement graph, the generation unit 123 transmits the endorsement graph to the terminal device 40 of the viewer P4.

The analysis unit 124 generates statistical information indicating statistics of an appearance frequency of the ED issuer ID that appears in the trust list, and caches a part of the endorsement graph determined based on the statistical information in the data storage unit 111. In this case, the acquisition unit 121 obtains the trust list from a terminal device (not illustrated) of another viewer different from the terminal device 40 in addition to the terminal device 40 of the viewer P4. The analysis unit 124 generates statistical information indicating statistics of the appearance frequency of the ED issuer ID that appears in each of the plurality of trust lists obtained by the acquisition unit 121.

Note that, although details will be described later, the analysis unit 124 gives a score indicating reliability of the ED issuer ID to the ED issuer ID based on the appearance frequency of the ED issuer ID that appears in the plurality of trust lists and a predetermined weight. Then, based on the magnitude of the score, the analysis unit 124 caches, in the data storage unit 111, an endorsement graph including a predetermined number of ED issuer IDs to which a high score is given. The predetermined number is set in advance by an administrator of the data processing server 100.

Furthermore, the analysis unit 124 may give a first score indicating the reliability of the ED issuer ID to the ED issuer ID based on a first weight and the appearance frequency of the ED issuer ID in the plurality of trust lists. Meanwhile, the analysis unit 124 may give a second score indicating the reliability of the ED issuer ID based on a second weight and the appearance frequency of the ED issuer ID in a trust list for an endorsement graph for posted data in a common field. Then, the analysis unit 124 may calculate a total score of the first score and the second score, and may cache the endorsement graph including the predetermined number of ED issuer IDs based on the magnitude of the total score.

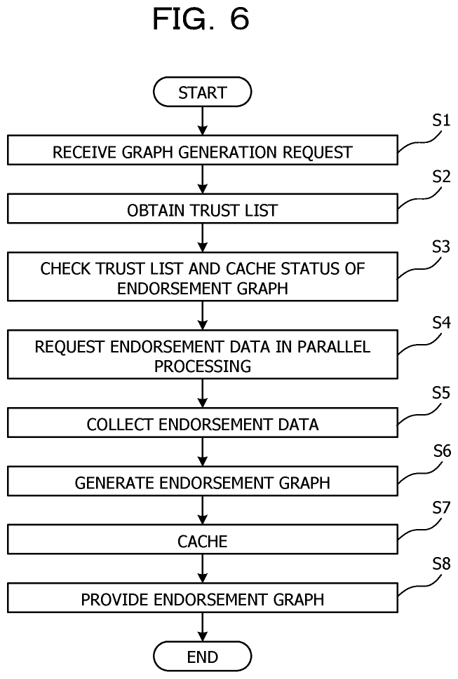

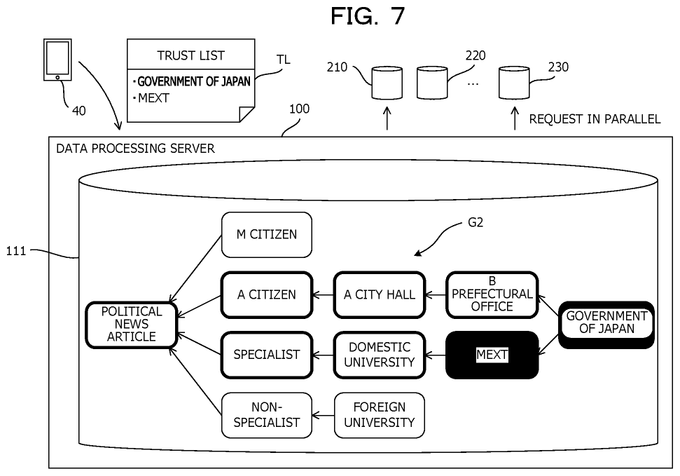

Exemplary operation of the data processing server 100 will be described with reference to FIGS. 6 and 7.

First, as illustrated in FIG. 6, the acquisition unit 121 receives a graph generation request related to the ED issuance target ID (operation S1). For example, the acquisition unit 121 receives, from the terminal device 40, a graph generation request of an endorsement graph including a target ED issuance target ID. For example, the acquisition unit 121 receives a graph generation request of the endorsement graph including the ED issuance target ID “political news article”. As a result, as illustrated in FIG. 7, the acquisition unit 121 identifies the endorsement graph G2 including the ED issuance target ID “political news article”.

When the processing of operation S1 ends, as illustrated in FIG. 6, the acquisition unit 121 obtains the trust list (operation S2). For example, the acquisition unit 121 obtains the trust list by requesting the terminal device 40 to transmit the trust list. For example, as illustrated in FIG. 7, the acquisition unit 121 obtains a trust list TL including ED issuer IDs “Government of Japan” and “Ministry of Education, Culture, Sports, Science and Technology (MEXT)”.

When the processing of operation S2 ends, as illustrated in FIG. 6, the collection unit 122 checks the trust list and the cache status of the endorsement graph (operation S3). For example, as illustrated in FIG. 7, the collection unit 122 refers to the data storage unit 111 and confirms the trust list TL and the cache status of the endorsement graph G2 identified by the acquisition unit 121. Then, the collection unit 122 specifies the ED issuer ID and a part of the endorsement graph G2 directly or indirectly associated with the ED issuer ID in one direction based on the ED issuer ID included in the trust list TL. According to the present embodiment, the collection unit 122 specifies a part of the endorsement graph G2 in which ED issuer IDs “M citizen”, “foreign university”, and “non-specialist” are excluded from the entire endorsement graph G2.

When the processing of operation S3 ends, as illustrated in FIG. 6, the collection unit 122 requests the endorsement data in parallel processing (operation S4). For example, as illustrated in FIG. 7, when a part of the endorsement graph G2 is specified, the collection unit 122 requests the endorsement data to at least one of the data management servers 210, 220, or 230 designated by individual ED storage URLs in parallel processing based on the individual ED storage URLs (see FIG. 4) associated with the specified part of the endorsement graph G2. Since the collection unit 122 collectively requests the endorsement data in parallel processing without recursively requesting it in order from the endorsement data close to the ED issuance target ID “political news article”, it becomes possible to shorten a collection time of the endorsement data.

When the processing of operation S4 ends, as illustrated in FIG. 6, the collection unit 122 collects the endorsement data (operation S5). As illustrated in FIG. 7, the collection unit 122 collects the endorsement data related to a part of the endorsement graph G2 in parallel to request the endorsement data in parallel processing. In this manner, the collection unit 122 collects the endorsement data using the existing endorsement graph G2 cached in the data storage unit 111.

If the endorsement graph G2 is not cached in the data storage unit 111, the collection unit 122 needs to individually and recursively collect the endorsement data to generate the endorsement graph G2. However, according to the present embodiment, it is not needed to individually and recursively collect the endorsement data, and the collection unit 122 is enabled to collectively collect the endorsement data in parallel.

When the processing of operation S5 ends, as illustrated in FIG. 6, the generation unit 123 generates an endorsement graph (operation S6). Since the endorsement data includes the ED issuer ID and the ED issuance target ID, the generation unit 123 generates the endorsement graph based on both of the relationship between the ED issuer ID and the ED issuance target ID of the endorsement data collected by the collection unit 122 and the relationship between the ED issuer ID and the ED issuance target ID of the endorsement data not collected by the collection unit 122. For example, the generation unit 123 newly generates an endorsement graph in which a part of the endorsement graph is updated.

When the processing of operation S6 ends, as illustrated in FIG. 6, the generation unit 123 caches the endorsement graph (operation S7). For example, the generation unit 123 deletes the previous endorsement graph, and caches the new endorsement graph generated in the processing of operation S6. As a result, the entire endorsement graph is updated.

When the processing of operation S7 ends, as illustrated in FIG. 6, the generation unit 123 provides the endorsement graph (operation S8), and the process is terminated. For example, the generation unit 123 provides the endorsement graph to the terminal device 40 by transmission, and terminates the process. As a result, the viewer P4 who operates the terminal device 40 is enabled to check the endorsement graph associated with the posted data in a relatively short time.

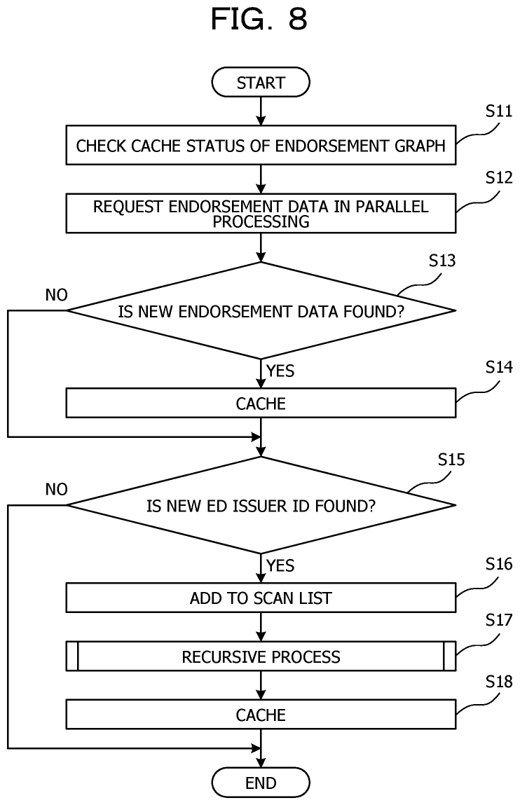

Next, another exemplary operation of the data processing server 100 will be described with reference to FIGS. 8 to 11. In the exemplary operation described above, it has been described that the trust list TL that defines the ED issuer IDs of authorized publishers, such as public institutions trusted by the viewer P4, is used. Meanwhile, the data processing server 100 may periodically update the endorsement graph based on prior setting without obtaining the trust list TL.

First, as illustrated in FIG. 8, the collection unit 122 checks the cache status of the endorsement graph (operation S11). For example, upon detection of predetermined time in a midnight period set by the administrator who manages the data processing server 100, the collection unit 122 checks the cache status of the endorsement graph.

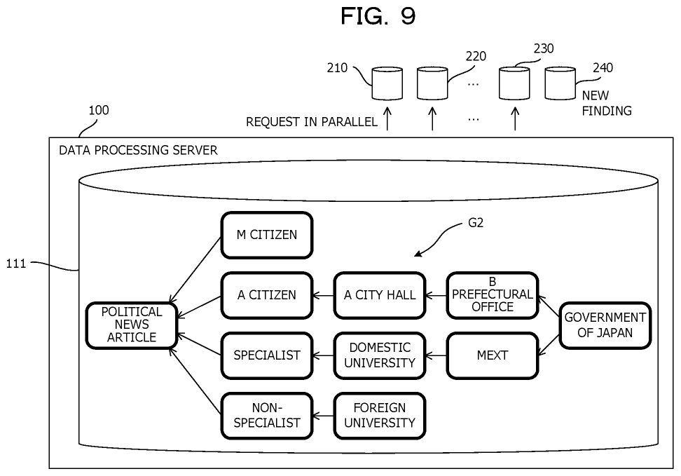

When the processing of operation S11 ends, the collection unit 122 requests the endorsement data in parallel processing (operation S12). For example, as illustrated in FIG. 9, the collection unit 122 specifies the whole part of the endorsement graph G2. For example, the collection unit 122 specifies all the ED issuance target IDs and ED issuer IDs included in the endorsement graph G2. Then, the collection unit 122 requests the endorsement data to the data management servers 210, 220, and 230 designated by the individual ED storage URLs in parallel processing based on all of the individual ED storage URLs (see FIG. 4) associated with the specified whole part of the endorsement graph G2. Even if the trust list TL is not used, the collection unit 122 collectively requests in parallel processing, whereby it becomes possible to shorten the collection time of the endorsement data.

When the processing of operation S12 ends, as illustrated in FIG. 8, the collection unit 122 determines whether or not new endorsement data has been found (operation S13). For example, as illustrated in FIG. 9, when the collection unit 122 requests the endorsement data in parallel processing, a data management server 240 that stores new endorsement data may be included in the endorsement system 50. In such a case, the collection unit 122 determines that new endorsement data has been found (YES in operation S13). On the other hand, if the data management server 240 that stores the new endorsement data is not included in the endorsement system 50, the collection unit 122 determines that the new endorsement data has not been found (NO in operation S13).

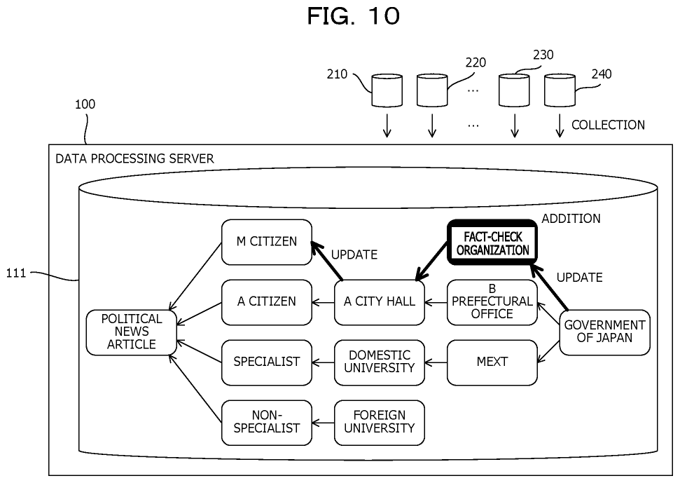

When the new endorsement data is found, the collection unit 122 caches the new endorsement data (operation S14). For example, as illustrated in FIG. 10, the collection unit 122 collects existing endorsement data from the data management servers 210, 220, and 230, and also collects the new endorsement data from the data management server 240. Then, the collection unit 122 additionally caches a part of metadata of the new endorsement data in the data storage unit 111.

In the present embodiment, the collection unit 122 additionally caches the ED issuer ID “fact-check organization”, the ED issuance target ID “A city hall”, and a predetermined ED storage URL designating the data management server 240, which are a part of the metadata of the new endorsement data, in association with each other. Note that, if the new endorsement data has not been found, the collection unit 122 skips the processing of operation S14.

When the processing of operation S13 or S14 ends, as illustrated in FIG. 8, the collection unit 122 determines whether or not a new ED issuer ID has been found (operation S15). As described above, since the collection unit 122 collects the existing endorsement data, a new ED issuer ID may be found depending on the collected endorsement data.

For example, the collection unit 122 collects the endorsement data including the ED issuance target ID “M citizen” as a new ED issuance target ID using the ED issuer ID “A city hall” and the ED issuance target ID “A citizen” as existing metadata. In this case, the ED issuer ID “A city hall” corresponds to a new ED issuer ID for the endorsement data having the ED issuer ID “A citizen” as metadata.

As described above, if the collected endorsement data includes the new ED issuance target ID, the collection unit 122 determines that the new ED issuer ID has been found (YES in operation S15). On the other hand, if the collected endorsement data does not include the new ED issuance target ID, the collection unit 122 determines that the new ED issuer ID has not been found (NO in operation S15).

If the new ED issuer ID has been found, the collection unit 122 adds the new ED issuer ID to a scan list (operation S16). The scan list is a list that stores ED issuer IDs to be scanned in the subsequent recursive process. When the processing of operation S16 ends, the collection unit 122 executes the recursive process (operation S17). Although details will be described later, the recursive process is a process of recursively collecting the endorsement data and the like based on the scan list.

When the processing of operation S17 ends, the collection unit 122 caches the endorsement data and the like collected in the processing of operation S17 in the data storage unit 111 (operation S18), and terminates the process. Note that, if the new ED issuer ID has not been found, the collection unit 122 skips the processing of operations S16 to S18, and terminates the process.

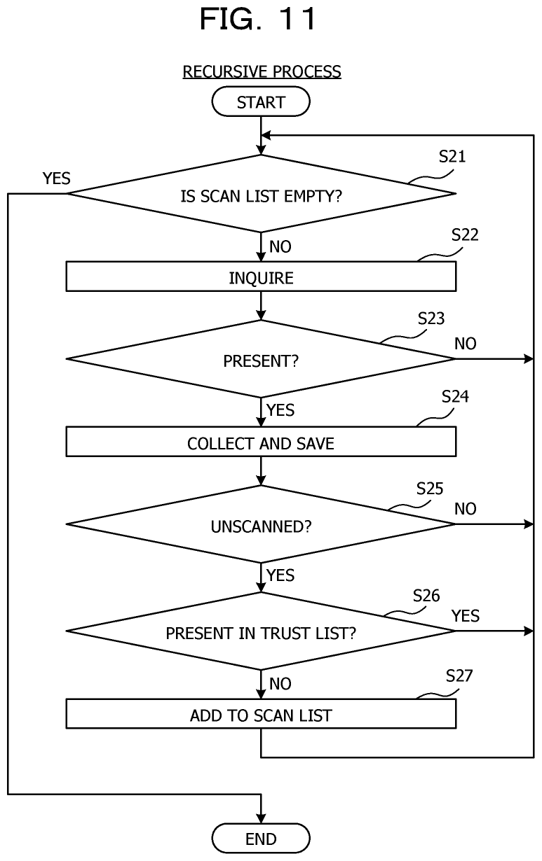

The recursive process will be described with reference to FIG. 11. As described above, when the processing of operation S16 ends, the collection unit 122 executes the recursive process. For example, as illustrated in FIG. 11, first, the collection unit 122 determines whether or not the scan list is empty (operation S21). If the scan list is empty (YES in operation S21), the collection unit 122 terminates the recursive process.

On the other hand, if the scan list is not empty (NO in operation S21), the collection unit 122 inquires about the endorsement data (operation S22). For example, the collection unit 122 extracts one ED issuer ID from the scan list. Then, the collection unit 122 inquires the data management servers 210, 220, and 230 about presence or absence of the endorsement data in which the extracted ED issuer ID serves as an ED issuance target ID.

If there is no such endorsement data (NO in operation S23), the collection unit 122 executes the processing of operation S21 again. On the other hand, if there is such endorsement data (YES in operation S23), the collection unit 122 collects the endorsement data, and saves a part of the metadata of the endorsement data in the data storage unit 111 (operation S24).

When the processing of operation S24 ends, the collection unit 122 determines whether or not the ED issuer ID of the saved endorsement data is unscanned (operation S25). If it is not unscanned (NO in operation S25), the collection unit 122 executes the processing of operation S21 again. On the other hand, if it is unscanned (YES in operation S25), the collection unit 122 determines whether or not the ED issuer ID of the saved endorsement data is present in the trust list (operation S26).

If it is present in the trust list (YES in operation S26), the collection unit 122 executes the processing of operation S21 again. On the other hand, if it is not present in the trust list (NO in operation S26), the collection unit 122 adds the ED issuer ID to the scan list (operation S27), and executes the processing of operation S21 again. As described above, if the scan list is empty in the processing of operation S21, the collection unit 122 terminates the recursive process.

As described above, the data processing server 100 according to the first embodiment obtains the trust list from the terminal device 40 of the viewer P4, and caches all or a part of the endorsement graph determined based on the trust list and the previous endorsement graph. As a result, it becomes possible to shorten a generation time of the endorsement graph.

### Second Embodiment

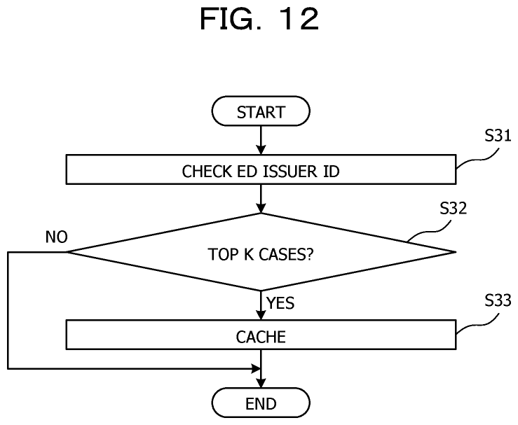

A second embodiment of the present case will be described with reference to FIGS. 12 to 15. In the second embodiment, a data amount of metadata of endorsement data uselessly cached in a data storage unit 111 is reduced. With this arrangement, storable capacity in which the data storage unit 111 may store the metadata increases, and the data storage unit 111 is enabled to further store valid metadata. As described above, according to the second embodiment, an inefficient cache is suppressed, and cache efficiency improves.

First, as illustrated in FIG. 12, an analysis unit 124 checks an ED issuer ID (operation S31). For example, the analysis unit 124 checks the ED issuer ID of the endorsement data collected by a collection unit 122. When the processing of operation S31 ends, the analysis unit 124 determines whether or not the ED issuer ID belongs to the top K cases (K is the number of threshold values represented by a natural number) (operation S32). For example, the analysis unit 124 determines whether or not the ED issuer ID belongs to the top K cases based on a score given to the ED issuer ID.

Here, details of the score given to the ED issuer ID will be described. If an acquisition unit 121 obtains trust lists from terminal devices 40 different from each other, the analysis unit 124 generates statistical information indicating statistics of an appearance frequency of the ED issuer ID that appears in those trust lists. When a generation unit 123 updates the endorsement graph, the analysis unit 124 gives a score indicating usefulness of the ED issuer ID to the ED issuer ID based on the statistical information (e.g., performs scoring).

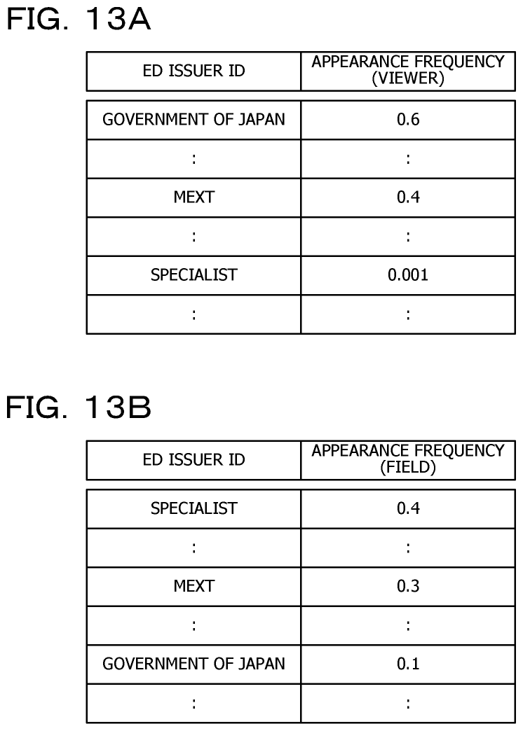

In this manner, the analysis unit 124 gives a score to the ED issuer ID based on the appearance frequency of the ED issuer ID. Here, the analysis unit 124 gives a score to the ED issuer ID based on the appearance frequency in various trust lists obtained by the acquisition unit 121. For example, as illustrated in FIG. 13A, if the appearance frequency of the ED issuer ID “Government of Japan” in the trust list is an appearance frequency “0.6”, the analysis unit 124 multiplies it by a predetermined first weight “1.0” to give a score “0.6” as a first score to the ED issuer ID. The ED issuer IDs “MEXT” and “specialist” are basically similar, and thus detailed descriptions thereof will be omitted. As a result, a high score is given to the ED issuer ID trusted by many viewers P4.

Furthermore, the analysis unit 124 gives a score to the ED issuer ID based on the appearance frequency in the trust list for the endorsement graph for posted data in a common field (e.g., politics, economy, entertainment, etc.). For example, as illustrated in FIG. 13B, if the appearance frequency of the ED issuer ID “specialist” in the trust list for the endorsement graph for the posted data in a common field is an appearance frequency “0.4”, the analysis unit 124 multiplies it by a predetermined second weight “1.0” to give a score “0.4” as a second score to the ED issuer ID. The ED issuer IDs “MEXT” and “Government of Japan” are basically similar, and thus detailed descriptions thereof will be omitted. As a result, a publisher of the endorsement data having more authority in a specific field is given a higher score in the endorsement graph for the posted data in that field.

The analysis unit 124 gives a score to the ED issuer ID based on a weighted average of those two types of appearance frequencies. For example, for the same ED issuer ID “Government of Japan”, the analysis unit 124 sums the first score “0.6” and the second score “0.1” (=“0.1”×“1.0”) to calculates a total score “0.7”. In this manner, the analysis unit 124 gives a score to each ED issuer ID, and determines whether or not the score is within the top K cases.

Note that the first weight and the second weight may be the same, or may be different. For example, one of the first weight and the second weight may be made larger than the other depending on the quality of the statistical information in each field. Furthermore, the number of threshold values described above is appropriately set by an administrator of a data processing server 100. For example, a larger number of threshold values is adopted for the endorsement data in which frequent inquiries occur. With this arrangement, the endorsement graph based on a large volume of metadata is cached in the data storage unit 111. On the other hand, a smaller number of threshold values is adopted for the endorsement data with a smaller number of inquiries. With this arrangement, the data amount of the metadata in the data storage unit 111 is reduced, and the storable capacity of the data storage unit 111 increases.

In this manner, in the processing of operation S32, the analysis unit 124 determines whether or not the ED issuer ID belongs to the top K cases. As illustrated in FIG. 12, if the ED issuer ID does not belong to the top K cases (NO in operation S32), the analysis unit 124 terminates the process. On the other hand, if the ED issuer ID belongs to the top K cases (YES in operation S32), the analysis unit 124 caches the metadata of the endorsement data including the ED issuer ID in the data storage unit 111 (operation S33), and terminates the process.

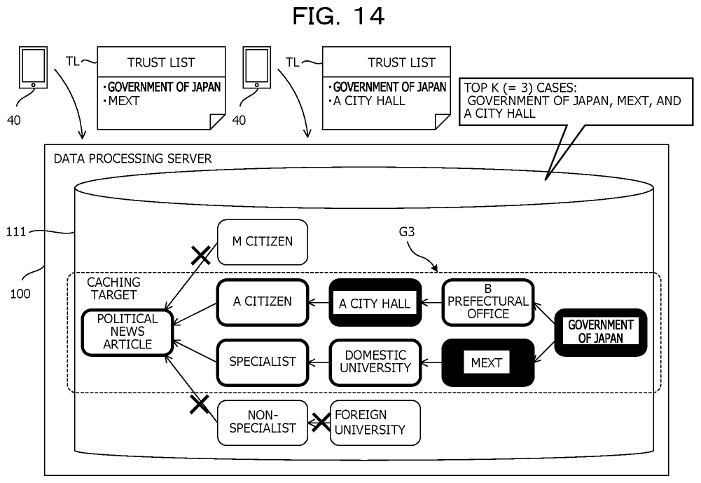

As a result, as illustrated in FIG. 14, an endorsement graph G3 based on some useful metadata is cached in the data storage unit 111. For example, caching of useless metadata in the data storage unit 111 is suppressed. According to FIG. 14, the endorsement graph G3 includes the ED issuer ID “Government of Japan”, “MEXT”, and “A city hall” belonging to the top three cases. Meanwhile, it becomes possible to suppress caching of useless metadata, such as ED issuer IDs “M citizen”, “non-specialist”, and “foreign university”. As described above, according to the second embodiment, the inefficient cache is suppressed, and the cache efficiency improves.

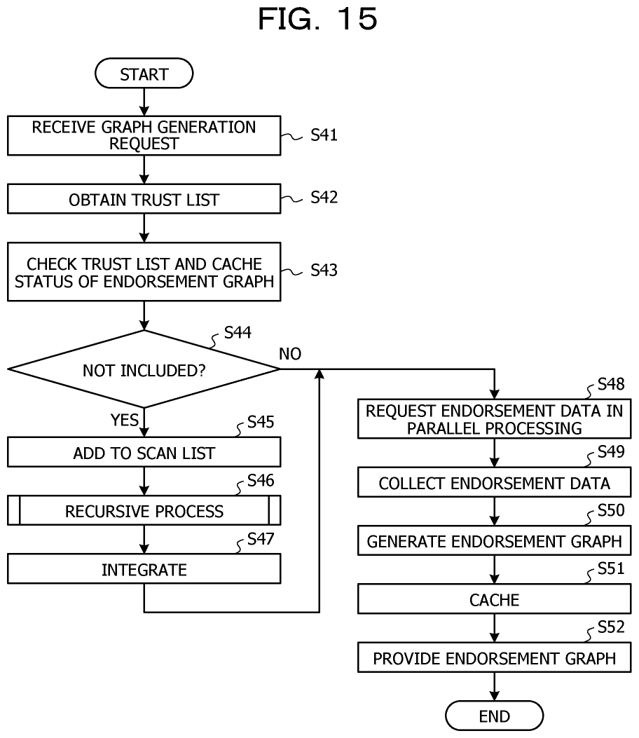

A process of collecting the endorsement data will be described with reference to FIG. 15. Note that detailed descriptions of processing similar to operations S1 to S8 described in the first embodiment will be omitted. First, the acquisition unit 121 receives a graph generation request related to an ED issuance target ID (operation S41). When the processing of operation S41 ends, the acquisition unit 121 obtains the trust list (operation S42). When the processing of operation S42 ends, the collection unit 122 checks the trust list and a cache status of the endorsement graph (operation S43).

When the processing of operation S43 ends, the collection unit 122 determines whether or not at least one or more of the ED issuer IDs stored in the trust list are not included in the cache status of the endorsement graph (operation S44). If at least one of more of the ED issuer IDs stored in the trust list are not included in the cache status of the endorsement graph (YES in operation S44), the collection unit 122 adds a new ED issuer ID to a scan list, and executes a recursive process (operations S45 and S46).

When the processing of operation S46 ends, the collection unit 122 caches the metadata of the collected endorsement data in the data storage unit 111, and integrates the metadata into the endorsement graph (operation S47). Note that the collection unit 122 skips the processing of operations S45 to S47 if at least one or more of the ED issuer IDs stored in the trust list are included in the cache status of the endorsement graph (NO in operation S44).

When the processing of operation S47 ends or the processing of operations S45 to S47 is skipped, the collection unit 122 requests the endorsement data in parallel processing (operation S48). When the processing of operation S48 ends, the collection unit 122 collects the endorsement data (operation S49). When the processing of operation S49 ends, the generation unit 123 generates an endorsement graph (operation S50). When the processing of operation S50 ends, the generation unit 123 caches the endorsement graph (operation S51).

When the processing of operation S51 ends, the generation unit 123 provides the endorsement graph (operation S52), and terminates the process. As described above, even if an ED issuer ID not included in the trust list exists in the cache status of the endorsement graph, the collection unit 122 is enabled to collect the endorsement data including the ED issuer ID not included in the trust list.

Although the preferred embodiments have been described in detail thus far, the embodiments are not limited to specific embodiments, and various modifications and alterations may be made within the scope of the present embodiments described in the claims. For example, in the second embodiment described above, the analysis unit 124 may give a score to the ED issuer ID based on one type of the appearance frequency.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a data processing program for causing a computer to execute a process, the process comprising:
obtaining, from a terminal of a viewer of data, the terminal requesting generation of an endorsement graph, a list in which an issuer of endorsement data trusted by the viewer is defined, when the generation of the endorsement graph in which connection of the endorsement data to which authenticity of data over an Internet is endorsed is graphed is requested; and
caching at least a part of the endorsement graph determined based on the list.

2. The non-transitory computer-readable recording medium according to claim 1, further comprising:
generating statistical information that indicates statistics of an appearance frequency of the issuer that appears in the list,
wherein the process caches the part of the endorsement graph determined based on the statistical information.

3. The non-transitory computer-readable recording medium according to claim 2, further comprising:
assigning a score that indicates reliability of the issuer to the issuer, based on the appearance frequency and a predetermined weight,
wherein the process caches the endorsement graph that includes a set predetermined number of the issuers, based on magnitude of the score.

4. The non-transitory computer-readable recording medium according to claim 2, further comprising:
assigning a first score that indicates reliability of the issuer to the issuer, based on a first weight and the appearance frequency in the list obtained from the terminal;
assigning a second score that indicates the reliability to the issuer, based on a second weight and the appearance frequency in the list for the endorsement graph for the data in a common field; and
obtaining a total score of the first score and the second score,
wherein the process caches the endorsement graph that includes a set predetermined number of the issuers, based on magnitude of the total score.

5. The non-transitory computer-readable recording medium according to claim 1, further comprising:
collecting the endorsement data in parallel, based on the cached endorsement graph.

6. The non-transitory computer-readable recording medium according to claim 1, wherein the endorsement graph is included in a directed graph that includes the issuer as a node and the endorsement data as an edge.

7. The non-transitory computer-readable recording medium according to claim 1, wherein the endorsement data includes the issuer and an issuance target of the endorsement data.

8. A data processing device comprising:
a memory; and
a processor coupled to the memory and configured to:
obtain, from a terminal of a viewer of data, the terminal requesting generation of an endorsement graph, a list in which an issuer of endorsement data trusted by the viewer is defined, when the generation of the endorsement graph in which connection of the endorsement data to which authenticity of data over an Internet is endorsed is graphed is requested; and
cache at least a part of the endorsement graph determined based on the list.

9. A data processing system comprising:
a terminal of a viewer of data, configured to request generation of an endorsement graph in which connection of endorsement data to which authenticity of data over an Internet is endorsed is graphed; and
a data processing device configured to obtain, from the terminal, a list in which an issuer of the endorsement data trusted by the viewer is defined when the generation of the endorsement graph is requested, and caches at least a part of the endorsement graph determined based on the list.
